(19) United States
(12) Patent Application Publication
(10) Pub. No.: US 2025/0329320 A1
(43) Pub. Date: Oct. 23, 2025

(54) Membrane Eartips and Earphones

(71) Applicant: HEAR LLC, Fairfax Station, VA (US)

(72) Inventor: John P. Keady, Fairfax Station, VA (US)

(73) Assignee: HEAR LLC, Fairfax Station, VA (US)

(21) Appl. No.: 19/182,551

(22) Filed: Apr. 17, 2025

Related U.S. Application Data
(60) Provisional application No. 63/634,925, filed on Apr. 17, 2024.

(51) Int. Cl. G10K 11/178; G10L 25/78

(52) U.S. Cl. CPC G10K 11/17823; G10K 11/17873; G10L 25/78; G10K 2210/1081; G10K 2210/3027

(57) ABSTRACT

The application discloses a deformable ear device having a stent having a distal end and an anti-distal end and a housing having a recess for a membrane attachment, an opening to accept the stent, and a grasp portion. The ear device includes a membrane attached to the stent and housing, wherein the membrane is deformed when the stent is twisted or moved.

### CROSS REFERENCE TO RELATED APPLICATIONS AND PRIORITY

The present application claims priority to and the benefit of U.S. Provisional Patent Application No. 63/634,925, filed 17 Apr. 2024, the entireties of which is hereby incorporated by reference.

### FIELD OF THE APPLICATION

The present application relates to devices that deform and expand to fit within ears, and more particularly, though not exclusively, devices that can be used in the ear.

### BACKGROUND

Hearing protection can take several forms such as earplugs and muffs. Such hearing protection devices attenuate acoustic energy before it reaches the eardrum (tympanum) by creating an insertion loss that is achieved by reflection of the sound waves, dissipation with the device's structure, impedance of the waves through tortuous paths, closing of acoustical valves, and other means. For a hearing protector, the amount of sound pressure level (SPL) reduced, usually measured in decibels (dB), is typically depicted graphically as a function of frequency. Most in-ear hearing protectors are only effective if they can be inserted and sealed. Typically, this involves compressing foam earplug and inserting for re-expansion, or inserting a flange earplug and hoping for correct insertion. Although a rolled foam earplug is smaller than the ear canal size, it's expansion does not start after the user is convinced of insertion depth and position it starts immediately upon insertion. A system that is smaller than the ear canal that can be inserted and positioned before expansion would be useful.

### SUMMARY

Devices, system and methods for membrane eartips, earplugs and earphones is disclosed.

These and other features of the eartip, earplug, earphone systems and methods are described in the following detailed description, drawings, and appended claims.

### BRIEF DESCRIPTION OF THE DRAWINGS

FIG. 1 illustrates a twist reduction earplug/earphone;

FIG. 2A, FIG. 2B, FIG. 2C, FIG. 2D, FIG. 2E and FIG. 2F illustrates the operation and parts of a twist reduction earplug/earphone;

FIG. 3A, FIG. 3B, FIG. 3C, FIG. 3D, FIG. 3E and FIG. 3F illustrates the operation and parts of a pinch reduction earplug/earphone;

FIG. 4A, FIG. 4B, FIG. 4C, FIG. 4D, FIG. 4E, FIG. 4F and FIG. 4G illustrates the operation and parts of a push reduction earplug/earphone;

FIG. 5A, FIG. 5B, FIG. 5C, FIG. 5D, FIG. 5E, FIG. 5F and FIG. 5G illustrates the operation and parts of a push/twist hybrid reduction earplug/earphone;

FIG. 6A, FIG. 6B, FIG. 6C, and FIG. 6D illustrates the operation and parts of a twist reduction earplug/earphone;

FIG. 7A illustrates the retention band earplug/earphone system used in a canine simulator;

FIG. 7B illustrates an asymmetric earplug/earphone;

FIG. 7C is a retention band that can be used to aid in earplug retention in animals;

FIG. 8A and FIG. 8B illustrates a push reduction earplug/earphone;

FIG. 9 illustrates a generic cross section of an ear canal;

FIG. 10 illustrates the general outer physiology of an ear;

FIG. 11 is a schematic diagram of a system for utilizing eartips according to an embodiment of the present disclosure; and

FIG. 12 is a schematic diagram of a machine in the form of a computer system within which a set of instructions, when executed, may cause the machine to perform any one or more of the methodologies or operations of the systems and methods for utilizing an eartip according to embodiments of the present disclosure.

### DETAILED DESCRIPTION OF THE INVENTION

### Non-limiting Nomenclature

10 earplug/earphone;
11 tip;
12 membrane;
13 stop flange;
14 grip;
100 earplug/earphone;
110 twist protrusion;
120 housing protrusion;
130 membrane;
135 membrane;
140 gap;
200 earplug/earphone;
205 earplug/earphone;
210 membrane;
220 fingers;
230 twist grip;
240 membrane;
250 membrane;
260 membrane;
270 twist stent;
280 housing;
300 earplug/earphone;
305 earplug/earphone;
310 membrane;
315 fingers;
320 membrane;
325 fingers;
345 housing protrusions;
355 pinched housing protrusions;
360 membrane;
370 membrane;
380 pinch housing;
390 pinch housing;
400 earplug/earphone;
405 membrane;
415 housing protrusion;
425 push stent;
435 fingers;
450 earplug/earphone;
455 membrane;
465 housing protrusion;
470 housing;
475 push stent;
480 push stent;
485 fingers;
500 earplug/earphone;
505 twist stent;
507 housing grip;
509 membrane;
510 grasp;
520 twist;
530 earplug/earphone;
535 fingers;
537 insert;
550 earplug/earphone;
570 ear canal with inserted earplug/earphone;
580 stop flange/housing;
585 grip housing;
590 push/twist stent;
600 earplug/earphone;
610 membrane;
620 push/twist tab;
630 stent;
640 housing;
650 distal end of stent;
665 interior of membrane;
670 stent;
672 distal end of stent;
674 push end of stent;
680 grip housing;
685 recession to fit push end of stent;
690 push tab;
700 canine ear canal model;
710 base ear retention band;
720 asymmetric earplug/earphone;
800 earplug/earphone;
810 push tab;
820 stent arm;
830 battery;
840 aperture;
850 housing;
860 membrane;
865 interior membrane;
870 flexible ridges;
880 flexible ridges;
890 mic/speaker;
895 channel;
825 stent protrusion;
900 cross section of ear canal;
905 ear canal;
910 cartilaginous region;
920 bony region;
930 aperture;
940 tympanic membrane;
1000 outer physiology of ear;
1060 auricle tubercle;
1065 antihelix;
1070 helix;
1075 antitragus;
1080 tragus;
1085 lobule;
1090 crus of helix;
1095 anterior notch; and
1098 intertragic incisures.

### Exemplary Embodiments of Eartips and Earplugs

In some embodiments, the durometer of a membrane/eartip can vary between 2 Shore A to 90 Shore A. Exemplary dimensions of the thickness of the eartip can be between approximately 0.001 mm to approximately 2 or more mm. The length (along the long axis) of an eartip/earplug/earphone can be from approximately 4 mm to approximately 100 mm or more depending upon the final usage. The outer diameter of the eartip/earplug/earphone can vary from approximately 3 mm to approximately 50 or more mm, typically approximately 8 mm to approximately 18 mm. Note that a stent can be fabricated from various materials (e.g., silicon, urethane, rubber) and can include internal channel (tubes). The stent can also be a multi-lumen (i.e., multi-passageway) stent where the channels/tubes are various lumens of the multi-lumen stent, or solid (e.g., earplug stent). Note that the material of the membrane can have different properties from the stent. The eartip/membrane can be formed of various flexible materials including, but not limited to, silicone, rubber (including high strength rubber, urethane, synthetic rubber, nitrile rubber, chloroprene rubber, EVA rubber), Quartz fibre, any other suitable material, or a combination thereof. Eartip/earphone/earplug parts can be molded or 3D printed, and various acoustic channels can be formed, for example, many complicated channels can be formed from 3D printing that cannot be molded.

### Methods of Manufacturing

The eartip/earplug/earphones can be fabricated by various means, for example injection molding, then sealed with various filler mediums (e.g. gas, liquid, gel), which can include a movable stent.

For example, specific materials may not be listed for achieving each of the targeted properties discussed, however one of ordinary skill would be able, without undo experimentation, to determine the materials needed given the enabling disclosure herein. For example Elastosil™ 30A, 70A, High Strength 1, 2, 3, Moldmaking Rubber (Alumilite™ products), flexible 3D printable material, silicon, urethane, natural and synthetic rubber, high strength rubber, chloroprene rubber, EVA rubber, quartz fiber, can be used; however, any material that can be used within the ear canal can be used for eartips and any material that can be used for earphones (silicon, urethane, rubber, plastic, Elastosil, metal, wood, and the like) can be used in the earphone housing and components thereof. As discussed herein, the eartips can be printed on three dimensional printers while provided the Shore A hardiness discussed herein.

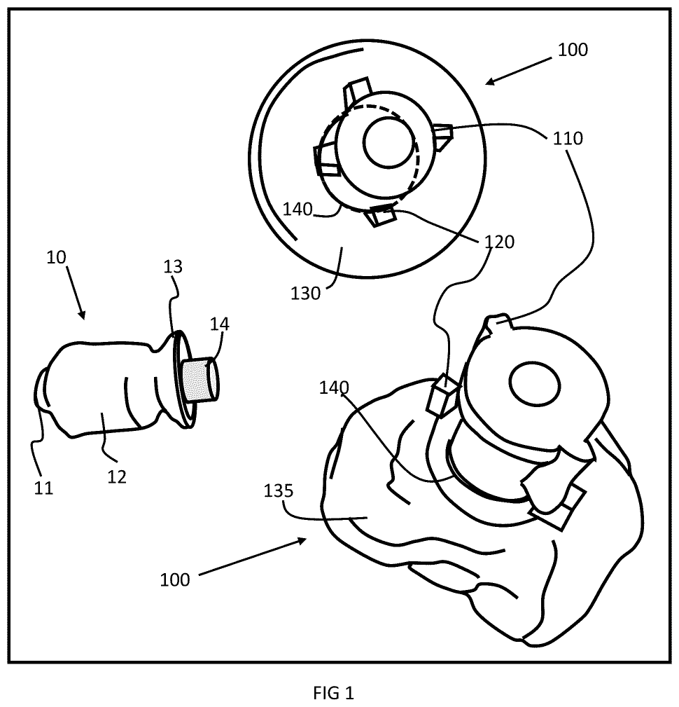

FIG. 1 illustrates a twist reduction earplugs/earphones 10 and 100. Earphone 10 can include a distal tip end 11 of a membrane, a membrane 12, stop flange 13 and a twist grip tab 14 of stent. A user can twist or push tab 14 so that a membrane cross section decreases, then the earplug/earphone 10 is inserted into an ear canal then re-expands when ungripped. To remove the user regrips 14 and pulls or twists to remove. Earplug/earphone 100 is a second embodiment of a twist earplug/earphone. A user can grab the housing tab 120, part of the housing 140, and the twist tab 110, and twist to reduce the diameter of membrane 130, reduced membrane 135. Then the twisted earplug/earphone 100 is inserted into tan ear canal then the user ungrasps the twist tab 110, which twists back to the untwisted position re-expanding the membrane to seal the ear canal.

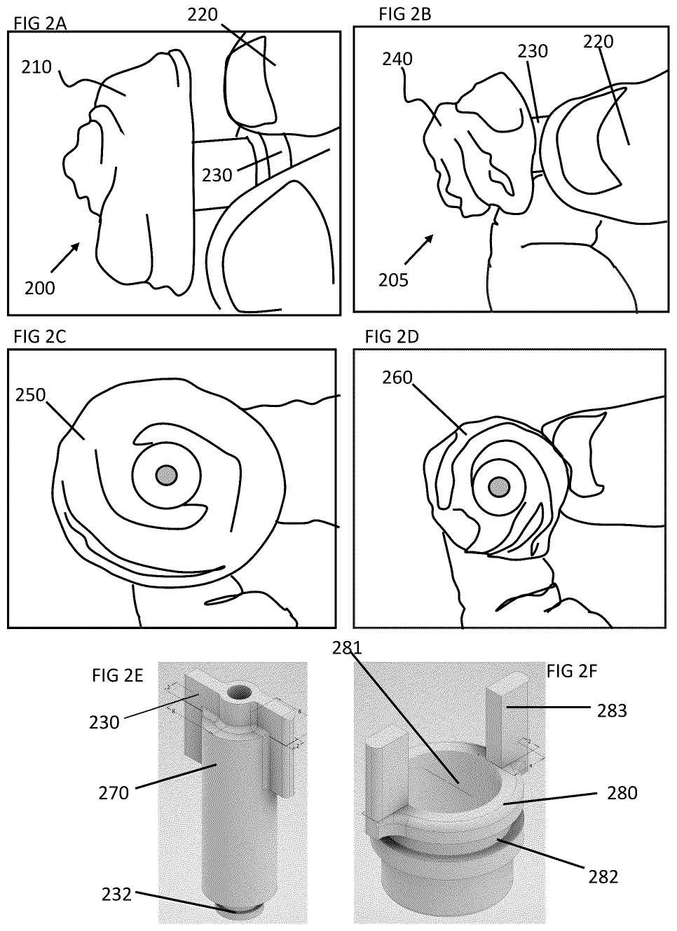

FIG. 2A, FIG. 2B, FIG. 2C, FIG. 2D, FIG. 2E and FIG. 2F illustrates the operation and parts of a twist reduction earplug/earphone. The use of a twist earplug/earphone 200 is illustrated in FIGS. 2A, 2B, 2C and 2D. A user uses their fingers 220 to grasp a twist tab 230 at the end of a rotatable stent. The rotatable stent is attached to the flexible membrane 210 such that when the stent is rotated the membrane 210 will twist reducing in diameter (260). The twisted membrane 240 is reduced in diameter. The twisted membrane earplug/earphone is then inserted into an ear canal, then the user's fingers 220 releases their grip on twist tab 230 and the twisted membrane 240 will re-expand (250) to fit the ear canal, sealing it. A non-limiting example of a twist stent 270 having a twist tab 230 is shown in FIG. 2E. The membrane is attached to distal end of the stent 232. The twist stent 270 fits within an opening 281 in the housing 280, before attaching the membrane at 232. Then the other end of the membrane is attached to the housing at 282. After the membrane is attached to 232 and 282, when a user twists the stent tab 230 with respect to the housing tab 283 the membrane twists to reduce the diameter.

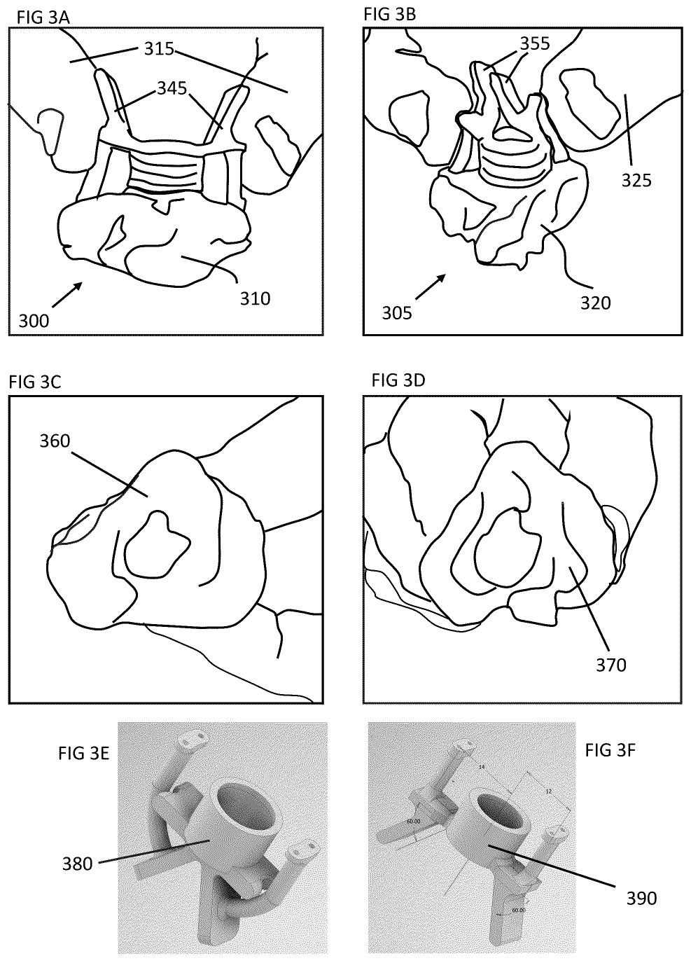

FIG. 3A, FIG. 3B, FIG. 3C, FIG. 3D, FIG. 3E and FIG. 3F illustrates the operation and parts of a pinch reduction earplug/earphone. The use of a pinch earplug/earphone 300 is illustrated in FIGS. 3A, 3B, 3C and 3D. A user uses their fingers 315 to grasp pinch tabs 345 at the end of a housing. The housing is attached to the flexible membrane 310 such that when the pinch tabs 345 are actuated the membrane 310 will bend reducing in diameter (370), a pinched earplug/earphone 305. The folded membrane 320 is reduced in diameter (370). The folded membrane earplug/earphone is then inserted into an ear canal, then the user's fingers 325 releases their grip on pinched tabs 355 and the folded membrane 320 will re-expand (360) to fit the ear canal, sealing it. A non-limiting example of pinch housings 380 and 390 are shown in FIGS. 3E and 3F respectively.

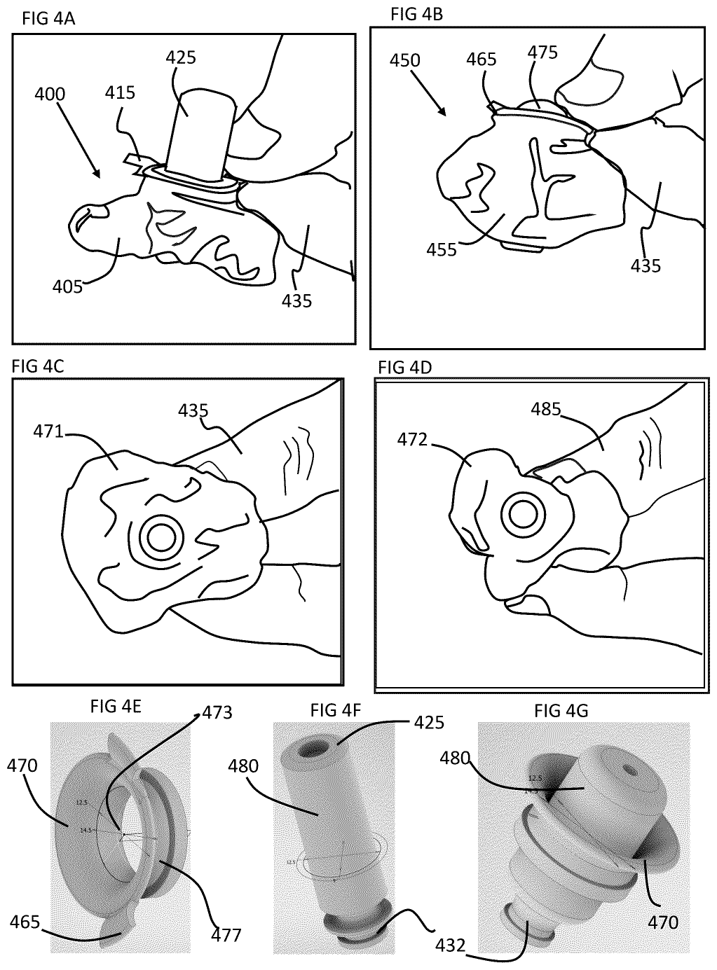

FIG. 4A, FIG. 4B, FIG. 4C, FIG. 4D, FIG. 4E, FIG. 4F and FIG. 4G illustrates the operation and parts of a push reduction earplug/earphone. The use of a push reduction earplug/earphone 400 is illustrated in FIGS. 4A, 4B, 4C and 4D. A user uses their fingers 435 to push (475) reduction tab 425 at the end of a movable stent. The movable stent stent is attached to the flexible membrane 405 such that when the stent is moved the membrane 405 will reduce in diameter (from 471 to 472). The deformed membrane 455 is reduced in diameter (472). The deformed membrane earplug/earphone is then inserted into an ear canal, then the user's fingers 435 releases their push (475) and the deformed membrane 455 will re-expand (471) to fit the ear canal, sealing it. A non-limiting example of a push stent 480 having a push reduction tab 425 is shown in FIG. 4F. The membrane is attached to distal end of the stent 432. The push reduction stent 480 fits within an opening 473 in the housing 470, before attaching the membrane at 432. Then the other end of the membrane is attached to the housing at 477. After the membrane is attached to 432 and 477, when a user pushes the stent tab 425 with respect to the housing tab 465 the membrane deforms to reduce the diameter (472).

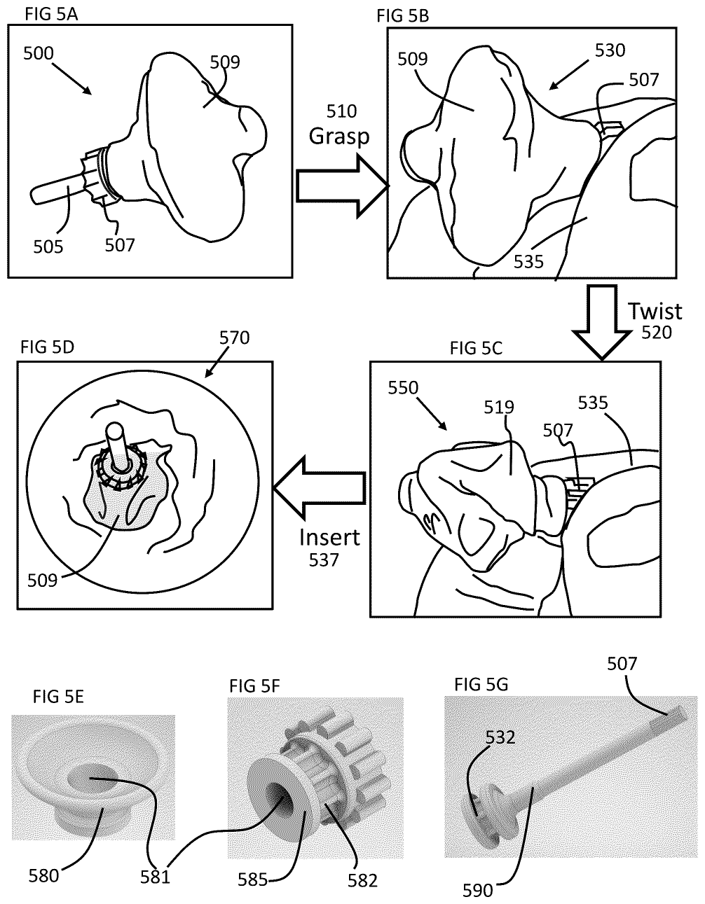

FIG. 5A, FIG. 5B, FIG. 5C, FIG. 5D, FIG. 5E, FIG. 5F and FIG. 5G illustrates the operation and parts of a push/twist hybrid reduction earplug/earphone. The use of a twist earplug/earphone 500 is illustrated in FIGS. 5A, 5B, 5C and 5D. A user uses their fingers 535 to grasp a twist tab 507 at the end of a rotatable stent. The rotatable stent is attached to the flexible membrane 509 such that when the stent is rotated the membrane 509 will twist reducing in diameter (550). The twisted membrane earplug/earphone 550 is then inserted 537 into an ear canal 570, then the user's fingers 535 releases their grip on twist tab 507 and the twisted membrane 519 will re-expand (509) to fit the ear canal, sealing it. A non-limiting example of a twist stent 590 having a twist tab 507 is shown in FIG. 5G. The membrane is attached to distal end of the stent 532. The twist stent 590 fits within an opening 581 in the housing (585, 580), before attaching the membrane at 532. Then the other end of the membrane is attached to the housing at 582. After the membrane is attached to 532 and 582, when a user twists the stent tab 507 with respect to the housing (585, 580) the membrane twists to reduce the diameter. The stent 590 can be a hybrid stent which can be pushed or twisted.

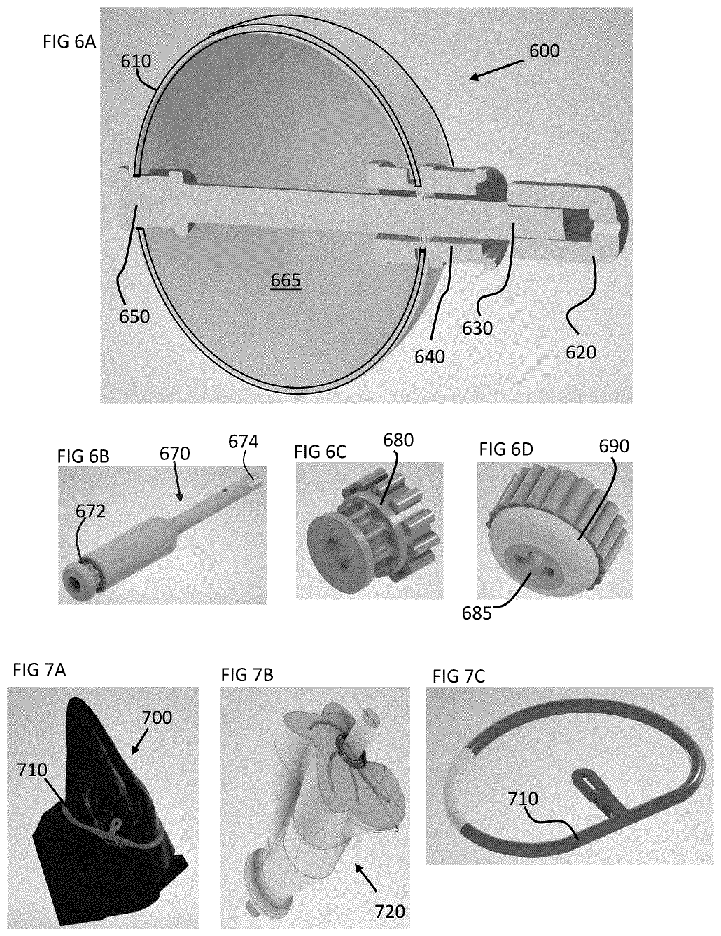

FIG. 6A, FIG. 6B, FIG. 6C, and FIG. 6D illustrates the operation and parts of a twist/push reduction earplug/earphone 600. The twist/push reduction earplug/earphone 600 includes a membrane 610, defining an interior 665, which can be fluid filled (liquid, gas), a stent 630, which can have a distal end 650 and an antidistal end which can have a tab 620 attached. The stent 630 can move through the opening in a housing 640. The membrane 610 can be attached at the distal end 650 and the other end attached at the housing 640. A stent (670) can have a distal end 672 and an end 674 that can be attached to a twist or push tab 690 by a recess 685. The stent 670 can fit through an opening in the housing 680.

FIG. 7A illustrates the retention band earplug/earphone system used in a canine simulator. An asymmetric earplug/earphone (720) (FIG. 7B) can fit within the canine ear canal 700, which can be retained by a retention band 710 (FIG. 7C).

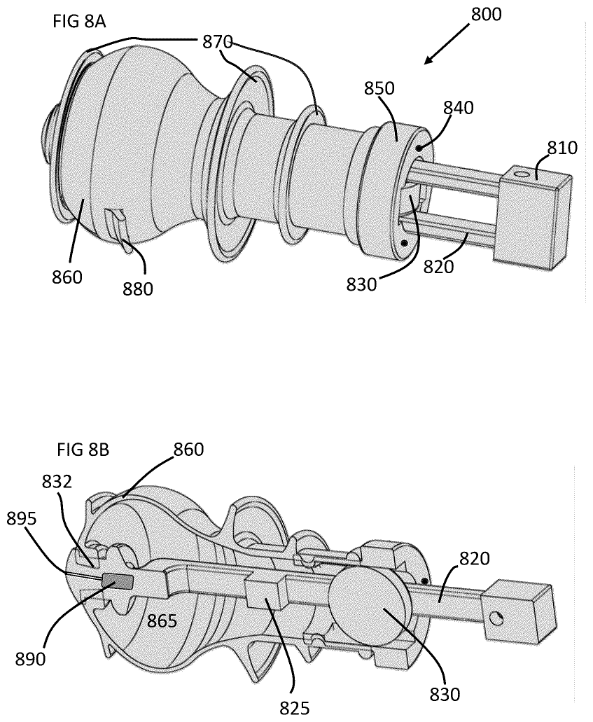

FIG. 8A and FIG. 8B illustrates a push reduction earplug/earphone 800. The earplug/earphone can include a flexible membrane 860, which can include ridges 870 and 880. The membrane 860 can be attached to a movable stent 820 at the distal end 832 and to the housing 850. The earphone 800 version can include a speaker/microphone 890 which can direct acoustic energy into an acoustic channel 895. The membrane 860 can define an interior region 865. The stent 820 can include a tab 825 that can be used when the stent 820 is moved to remove a battery 830. The earphone version 800 can also include ear canal microphones that also use the acoustic channel 895, as well an ambient sound microphones that measure sound through microphone ports 840. The earphone version 800 can include processors, chips, memory, transceivers and other earphone related electronics. Note that the membrane 860 can be asymmetric. The ridges 870 and 880 can be designed to aid in retention in an ear canal.

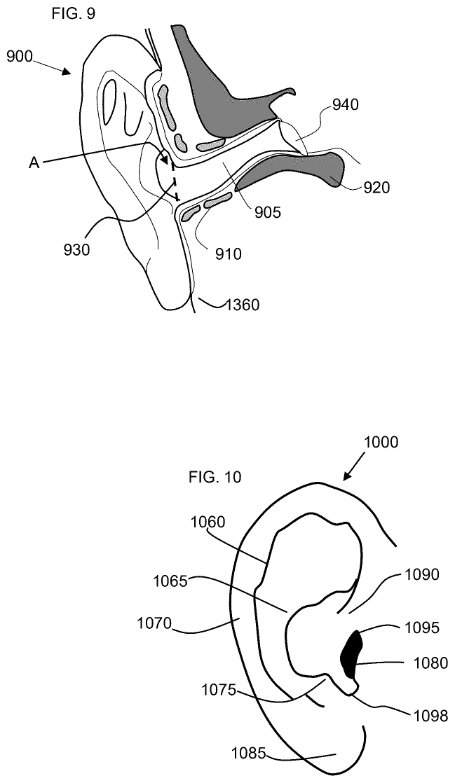

FIG. 9 illustrates a cross section of an ear canal 900, including a cartilaginous region 910 and a bony region 920 of an ear canal 900. The entrance of the ear canal 900 is referred to as the aperture 930 and defines a first end of the ear canal 900 while the tympanic membrane 940 defines the other, internal end of the ear canal 200.

FIG. 10 illustrates the outer physiology of ear 1000, which includes an auricle tubercle 1060, the antihelix 1065, the helix 1070, the antitragus 1075, tragus 1080, lobule 1085 of ear 1000, crus of helix 1090, anterior notch 1095, and intertragic incisures 1098.

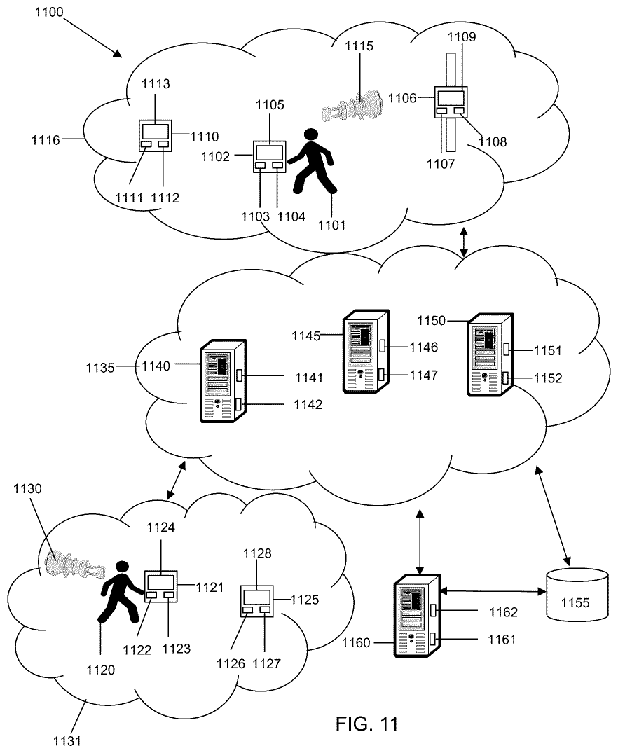

As shown in FIG. 11, a system 1100 and methods for utilizing eartips and/or earphone devices are disclosed.

The system 1100 may be configured to support, but is not limited to supporting, data and content services, audio processing applications and services, audio output and/or input applications and services, applications and services for transmitting and receiving audio content, authentication applications and services, computing applications and services, cloud computing services, internet services, satellite services, telephone services, software as a service (SaaS) applications, platform-as-a-service (PaaS) applications, gaming applications and services, social media applications and services, productivity applications and services, voice-over-internet protocol (VoIP) applications and services, speech-to-text translation applications and services, interactive voice applications and services, mobile applications and services, and any other computing applications and services. The system may include a first user 1101, who may utilize a first user device 1102 to access data, content, and applications, or to perform a variety of other tasks and functions. As an example, the first user 1101 may utilize first user device 1102 to access an application (e.g. a browser or a mobile application) executing on the first user device 1102 that may be utilized to access web pages, data, and content associated with the system 1100. In certain embodiments, the first user 1101 may be any type of user that may potentially desire to listen to audio content, such as from, but not limited to, a music playlist accessible via the first user device 1102, a telephone call that the first user 1101 is participating in, audio content occurring in an environment in proximity to the first user 1101, any other type of audio content, or a combination thereof. For example, the first user 1101 may be an individual that may be participating in a telephone call with another user, such as second user 1120.

The first user device 1102 utilized by the first user 1101 may include a memory 1103 that includes instructions, and a processor 1104 that executes the instructions from the memory 1103 to perform the various operations that are performed by the first user device 1102. In certain embodiments, the processor 1104 may be hardware, software, or a combination thereof. The first user device 1102 may also include an interface 1105 (e.g. screen, monitor, graphical user interface, etc.) that may enable the first user 1101 to interact with various applications executing on the first user device 1102, to interact with various applications executing within the system 1100, and to interact with the system 1100 itself. In certain embodiments, the first user device 1102 may include any number of transducers, such as, but not limited to, microphones, speakers, any type of audio-based transducer, any type of transducer, or a combination thereof. In certain embodiments, the first user device 1102 may be a computer, a laptop, a tablet device, a phablet, a server, a mobile device, a smartphone, a smart watch, and/or any other type of computing device. Illustratively, the first user device 1102 is shown as a mobile device in FIG. 11. The first user device 1102 may also include a global positioning system (GPS), which may include a GPS receiver and any other necessary components for enabling GPS functionality, accelerometers, gyroscopes, sensors, and any other componentry suitable for a mobile device.

In addition to using first user device 1102, the first user 1101 may also utilize and/or have access to a second user device 1106 and a third user device 1110. As with first user device 1102, the first user 1101 may utilize the second and third user devices 1106, 1110 to transmit signals to access various online services and content. The second user device 1106 may include a memory 1107 that includes instructions, and a processor 1108 that executes the instructions from the memory 1107 to perform the various operations that are performed by the second user device 1106. In certain embodiments, the processor 1108 may be hardware, software, or a combination thereof. The second user device 1106 may also include an interface 1109 that may enable the first user 1101 to interact with various applications executing on the second user device 1106 and to interact with the system 1100. In certain embodiments, the second user device 1106 may include any number of transducers, such as, but not limited to, microphones, speakers, any type of audio-based transducer, any type of transducer, or a combination thereof. In certain embodiments, the second user device 1106 may be and/or may include a computer, any type of sensor, a laptop, a set-top-box, a tablet device, a phablet, a server, a mobile device, a smartphone, a smart watch, and/or any other type of computing device. Illustratively, the second user device 102 is shown as a smart watch device in FIG. 11.

The third user device 1110 may include a memory 1111 that includes instructions, and a processor 1112 that executes the instructions from the memory 1111 to perform the various operations that are performed by the third user device 1110. In certain embodiments, the processor 1112 may be hardware, software, or a combination thereof. The third user device 1110 may also include an interface 1113 that may enable the first user 1101 to interact with various applications executing on the second user device 1106 and to interact with the system 1100. In certain embodiments, the third user device 1110 may include any number of transducers, such as, but not limited to, microphones, speakers, any type of audio-based transducer, any type of transducer, or a combination thereof. In certain embodiments, the third user device 1110 may be and/or may include a computer, any type of sensor, a laptop, a set-top-box, a tablet device, a phablet, a server, a mobile device, a smartphone, a smart watch, and/or any other type of computing device. Illustratively, the third user device 1110 is shown as a smart watch device in FIG. 11.

The first, second, and/or third user devices 1102, 1106, 1110 may belong to and/or form a communications network 1116. In certain embodiments, the communications network 1116 may be a local, mesh, or other network that facilitates communications among the first, second, and/or third user devices 1102, 1106, 1110 and/or any other devices, programs, and/or networks of system 1100 or outside system 1100. In certain embodiments, the communications network 1116 may be formed between the first, second, and third user devices 1102, 1106, 1110 through the use of any type of wireless or other protocol and/or technology. For example, the first, second, and third user devices 1102, 1106, 1110 may communicate with one another in the communications network 1116, such as by utilizing Bluetooth Low Energy (BLE), classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 1116 may be configured to communicatively link with and/or communicate with any other network of the system 1100 and/or outside the system 1100.

The system 1100 may also include an earphone device 1115, which the first user 1101 may utilize to hear and/or audition audio content, transmit audio content, receive audio content, experience any type of content, process audio content, adjust audio content, store audio content, perform any type of operation with respect to audio content, or a combination thereof. The earphone device 1115 may be an earpiece, a hearing aid, an ear monitor, an ear terminal, a behind-the-ear device, any type of acoustic device, or a combination thereof. The earphone device 1115 may include any type of component utilized for any type of earpiece. In certain embodiments, the earphone device 1115 may include any number of ambient sound microphones that may be configured to capture and/or measure ambient sounds and/or audio content occurring in an environment that the earphone device 1115 is present in and/or is proximate to. In certain embodiments, the ambient sound microphones may be placed at a location or locations on the earphone device 1115 that are conducive to capturing and measuring ambient sounds occurring in the environment. For example, the ambient sound microphones may be positioned in proximity to a distal end (e.g. the end of the earphone device 1115 that is not inserted into the first user's 1101 ear) of the earphone device 1115 such that the ambient sound microphones are in an optimal position to capture ambient or other sounds occurring in the environment. In certain embodiments, the earphone device 1115 may include any number of ear canal microphones, which may be configured to capture and/or measure sounds occurring in an ear canal of the first user 1101 or other user wearing the earphone device 1115. In certain embodiments, the ear canal microphones may be positioned in proximity to a proximal end (e.g. the end of the earphone device 1115 that is inserted into the first user's 1101 ear) of the earphone device 1115 such that sounds occurring in the ear canal of the first user 101 may be captured more readily.

The earphone device 1115 may also include any number of transceivers, which may be configured transmit signals to and/or receive signals from any of the devices in the system 1100. In certain embodiments, a transceiver of the earphone device 1115 may facilitate wireless connections and/or transmissions between the earphone device 1115 and any device in the system 1100, such as, but not limited to, the first user device 1102, the second user device 1106, the third user device 1110, the fourth user device 1121, the fifth user device 1125, the earphone device 1130, the servers 1140, 1145, 1150, 1160, and the database 1155. The earphone device 1115 may also include any number of memories for storing content and/or instructions, processors that execute the instructions from the memories to perform the operations for the earphone device 1115, and/or any type integrated circuit for facilitating the operation of the earphone device 1115. In certain embodiments, the processors may comprise, hardware, software, or a combination of hardware and software. The earphone device 1115 may also include one or more ear canal receivers, which may be speakers for outputting sound into the ear canal of the first user 1101. The ear canal receivers may output sounds obtained via the ear canal microphones, ambient sound microphones, any of the devices in the system 1100, from a storage device of the earphone device 1115, or any combination thereof.

The ear canal receivers, ear canal microphones, transceivers, memories, processors, integrated circuits, and/or ear canal receivers may be affixed to an electronics package that includes a flexible electronics board. The earphone device 1115 may include an electronics packaging housing that may house the ambient sound microphones, ear canal microphones, ear canal receivers (i.e. speakers), electronics supporting the functionality of the microphones and/or receivers, transceivers for receiving and/or transmitting signals, power sources (e.g. batteries and the like), any circuitry facilitating the operation of the earphone device 1115, or any combination thereof. The electronics package including the flexible electronics board may be housed within the electronics packaging housing to form an electronics packaging unit. The earphone device 1115 may further include an earphone housing, which may include receptacles, openings, and/or keyed recesses for connecting the earphone housing to the electronics packaging housing and/or the electronics package. For example, nozzles of the electronics packaging housing may be inserted into one or more keyed recesses of the earphone housing so as to connect and secure the earphone housing to the electronics packaging housing. When the earphone housing is connected to the electronics packaging housing, the combination of the earphone housing and the electronics packaging housing may form the earphone device 1115. The earphone device 1115 may further include a cap for securing the electronics packaging housing, the earphone housing, and the electronics package together to form the earphone device 1115.

In certain embodiments, the earphone device 1115 may be configured to have any number of changeable tips, which may be utilized to facilitate the insertion of the earphone device 1115 into an ear aperture of an ear of the first user 1101, secure the earphone device 1115 within the ear canal of an ear of the first user 1101, and/or to isolate sound within the ear canal of the first user 1101. The tips may be foam tips, which may be affixed onto an end of the earphone housing of the earphone device 1115, such as onto a stent and/or attachment mechanism of the earphone housing. In certain embodiments, the tips may be any type of eartip as disclosed and described in the present disclosure. The eartips as disclosed in the present disclosure may be configured to facilitate distributed reduced contact force, sound isolation for sound in the ear canal of the first user 1101 (i.e. between the ambient environment and the ear canal environment within an ear of the first user 1101), mold into a variety of forms and/or positions, encapsulate volumes upon insertion into an ear aperture of the first user 1101, have a pressure adjusting design, facilitate notched stent retention (i.e. on a stent of the earphone housing), facilitate stent insertion into an ear canal of the first user 1101 via an ear aperture of the first user 1101, or any combination thereof. In certain embodiments, the eartip may be designed to provide sound isolation capability that is at least as effective as conventional foam and/or flange tips. Notably, the eartips may be manufactured and configured to be made in any desired size specifications and/or materials, and may be tailored to each individual user, such as first user 1101. In contrast to conventional foam or flange tips, an eartip according to the present disclosure may be adjusted for size without having to substitute the eartip with another eartip, may have an EPA NRR rating of NRR=18, may have a unique flatter high frequency attenuation profile so as to maintain audio quality, may have ease of manufacturability, and may be designed to distribute contact force and minimize radial force against a user's ear canal walls when positioned in a user's ear canal. Additionally, an eartip according to the present disclosure may be made of a non-porous material that is not closed cell foam or open cell foam.

In certain embodiments, the eartip may be designed so that the earphone device's 1115 retention force on the ear canal walls of the first user 1101 may be distributed over a larger area than traditional foam or flange tips allow, thereby reducing the pressure on the ear canal walls of the first user 1101. Unlike foam tips, which primarily provide a restoring radial force that exerts pressure against the ear canal walls of a user, the eartip is designed to move both radially and axially, which allows for more give and redistribution of contact over a larger area, and, thus, decreases the retention pressure. As a result, this allows for increased comfort for the user and allows the user to utilize the eartip for an extended period of time when compared to traditional foam and/or flange tips. In certain embodiments, the eartip utilized with the earphone device 1115 may be configured to encapsulate a volume of gas and/or liquid. In either case (i.e. gas or liquid), the bulk of sound isolation provided by the eartip is achieved through the reflection of ambient sound waves so that the encapsulated volume can be low mass. In certain embodiments, portions of the eartip may encapsulate a volume with the ability to release volume when pressed upon without having to incorporate complicated valves. The encapsulated volume may be achieved by the ear canal wall pressing radially and/or axially against the outer surfaces of the eartip, which may force the outer portion of the eartip to seal with the inner portion of the eartip. In certain embodiments, the inner portion of the eartip may be small than the outer diameter of the stent of the earphone housing upon which the eartip is placed so that upon insertion of the eartip on the stent, the inner portion stretches outward to meet the outer surface of the eartip, which further facilitates the sealing of the ear canal of the first user 1101.

In certain embodiments, the stent of the eartip, over which the eartip is placed, may be designed to have a smaller diameter front end and a larger diameter middle section to promote retention of the eartip on the stent itself. In certain embodiments, a portion of the eartip may have an inner core diameter that is smaller than the stent outer diameter so that the eartip provides radial compression upon the stent so as to enhance sealing and to add friction to prevent axial slippage within the ear canal of the first user 1101. In certain embodiments, an increased mid-section inner core diameter of the eartip may be utilized (i.e. larger than the smaller inner core diameter of the eartip), which may be configured to line up with the mid-section outer diameter of the stent of the earphone housing of the earphone device 1115. This may provide axial stability for the earphone device 1115, while simultaneously preventing axial slippage from the ear canal of the first user 1101. In certain embodiments, the eartip may have an insertion end that has a funnel shape, which aids in inserting the eartip onto the stent of the earphone housing of the earphone device 1115.

In certain embodiments, the eartip has a configuration that applies minimal force against the first user's 1101 ear canal. Additionally, the eartip can seal the first user's 1101 ear canal by providing at least 15 dB of attenuation across frequency. To facilitate manufacturability, the eartip may be molded inverted, thereby allowing inexpensive mass production. Lips of the eartip may then be folded to contact ledges to for the eartip that may be utilized by the first user 1101. Sealing and comfort depend upon an accurate fit within the first user's 1101 ear canal, and, as a result, eartips according to the present disclosure may be manufactured in several single sizes, and, because of the unique design of the eartips, a single eartip may be adjusted to fit multiple sizes, which minimizes manufacturing costs, while allowing for more flexibility, versatility, and for a greater number of sizes for the eartip. Notably, any of the features of any of the eartips described in the present disclosure may be combined and/or interchanged with any other eartips described in the present disclosure. Furthermore, the shape, size, features and/or functionality of any of the components of the earphone device and/or hearbud housing device described in the present disclosure may be modified for each particular user for the shape and size of each user's ear aperture and/or ear canal, or a combination thereof.

Notably, in experiments conducted using the eartip, the experiments have shown that the eartip allows for similar levels of sound isolation when compared to conventional foam and/or flange tips. For example, experiments have shown that the eartips provided in the present disclosure provided a NRR of 18 with a generally flat high frequency profile. A flat attenuation profile maintains an ambient environment's frequency profile when level reduced by the attenuation, which can be useful in maintaining the quality of ambient speech and music (or other audio content) during the level reduction process.

In further embodiments, the eartip may be configured to have an open configuration prior to insertion onto a stent of the earphone housing and/or the earphone device 1115 itself. By having an open configuration, the eartip may be mass produced using conventional molding techniques and/or by utilizing 3D commercial printers. The open configuration of the eartip also facilitates molding, and can be 3D printed, where the open configuration allows for resin removal. For example, resin removal may be achieved by utilizing commercial 3D printers that allow the use of lower durometer materials, such as Stratasys machines and the like. In certain embodiments, since the eartip has an open configuration, which is then sealed, any additional pressure can force encapsulated gas out of the eartip relieving the feedback pressure so as to keep the comfort level for the first user 1101 relatively stable.

In addition to the first user 1101, the system 1100 may include a second user 1120, who may utilize a fourth user device 1121 to access data, content, and applications, or to perform a variety of other tasks and functions. Much like the first user 1101, the second user 1120 may be may be any type of user that may potentially desire to listen to audio content, such as from, but not limited to, a storage device of the fourth user device 1121, a telephone call that the second user 1120 is participating in, audio content occurring in an environment in proximity to the second user 1120, any other type of audio content, or a combination thereof. For example, the second user 1120 may be an individual that may be listening to songs stored in a playlist that resides on the fourth user device 1121. Also, much like the first user 1101, the second user 1120 may utilize fourth user device 1121 to access an application (e.g. a browser or a mobile application) executing on the fourth user device 1121 that may be utilized to access web pages, data, and content associated with the system 1100. The fourth user device 1121 may include a memory 1122 that includes instructions, and a processor 1123 that executes the instructions from the memory 1122 to perform the various operations that are performed by the fourth user device 1121. In certain embodiments, the processor 1123 may be hardware, software, or a combination thereof. The fourth user device 1121 may also include an interface 1124 (e.g. a screen, a monitor, a graphical user interface, etc.) that may enable the second user 1120 to interact with various applications executing on the fourth user device 1121, to interact with various applications executing in the system 1100, and to interact with the system 1100. In certain embodiments, the fourth user device 1121 may include any number of transducers, such as, but not limited to, microphones, speakers, any type of audio-based transducer, any type of transducer, or a combination thereof. In certain embodiments, the fourth user device 1121 may be a computer, a laptop, a tablet device, a phablet, a server, a mobile device, a smartphone, a smart watch, and/or any other type of computing device. Illustratively, the fourth user device 1121 may be a computing device in FIG. 11. The fourth user device 1121 may also include any of the componentry described for first user device 1102, the second user device 1106, and/or the third user device 1110. In certain embodiments, the fourth user device 1121 may also include a global positioning system (GPS), which may include a GPS receiver and any other necessary components for enabling GPS functionality, accelerometers, gyroscopes, sensors, and any other componentry suitable for a computing device.

In addition to using fourth user device 1121, the second user 1120 may also utilize and/or have access to a fifth user device 1125. As with fourth user device 1121, the second user 1120 may utilize the fourth and fifth user devices 1121, 1125 to transmit signals to access various online services and content. The fifth user device 1125 may include a memory 1126 that includes instructions, and a processor 1127 that executes the instructions from the memory 1126 to perform the various operations that are performed by the fifth user device 1125. In certain embodiments, the processor 1127 may be hardware, software, or a combination thereof. The fifth user device 1125 may also include an interface 1128 that may enable the second user 1120 to interact with various applications executing on the fifth user device 1125 and to interact with the system 1100. In certain embodiments, the fifth user device 1125 may include any number of transducers, such as, but not limited to, microphones, speakers, any type of audio-based transducer, any type of transducer, or a combination thereof. In certain embodiments, the fifth user device 1125 may be and/or may include a computer, any type of sensor, a laptop, a set-top-box, a tablet device, a phablet, a server, a mobile device, a smartphone, a smart watch, and/or any other type of computing device. Illustratively, the fifth user device 1125 is shown as a tablet device in FIG. 11.

The fourth and fifth user devices 1121, 1125 may belong to and/or form a communications network 1131. In certain embodiments, the communications network 1131 may be a local, mesh, or other network that facilitates communications between the fourth and fifth user devices 1121, 1125, and/or any other devices, programs, and/or networks of system 1100 or outside system 1100. In certain embodiments, the communications network 1131 may be formed between the fourth and fifth user devices 1121, 1125 through the use of any type of wireless or other protocol and/or technology. For example, the fourth and fifth user devices 1121, 1125 may communicate with one another in the communications network 1116, such as by utilizing BLE, classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 1131 may be configured to communicatively link with and/or communicate with any other network of the system 1100 and/or outside the system 1100.

Much like first user 1101, the second user 1120 may have his or her own earphone device 1130. The earphone device 1130 may be utilized by the second user 1120 to hear and/or audition audio content, transmit audio content, receive audio content, experience any type of content, process audio content, adjust audio content, store audio content, perform any type of operation with respect to audio content, or a combination thereof. The earphone device 1130 may be an earpiece, a hearing aid, an ear monitor, an ear terminal, a behind-the-ear device, any type of acoustic device, or a combination thereof. The earphone device 1130 may include any type of component utilized for any type of earpiece, and may include any of the features, functionality and/or components described and/or usable with earphone device 1115. For example, earphone device 1130 may include any number of transceivers, ear canal microphones, ambient sound microphones, processors, memories, housings, eartips, foam tips, flanges, any other component, or any combination thereof.

In certain embodiments, the first, second, third, fourth, and/or fifth user devices 1102, 1106, 1110, 1121, 1125 and/or earphone devices 1115, 1130 may have any number of software applications and/or application services stored and/or accessible thereon. For example, the first and second user devices 1102, 1111 may include applications for processing audio content, applications for playing, editing, transmitting, and/or receiving audio content, streaming media applications, speech-to-text translation applications, cloud-based applications, search engine applications, natural language processing applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, presentation applications, any other type of applications, any types of application services, or a combination thereof. In certain embodiments, the software applications and services may include one or more graphical user interfaces so as to enable the first and second users 1101, 1120 to readily interact with the software applications. The software applications and services may also be utilized by the first and second users 1101, 1120 to interact with any device in the system 1100, any network in the system 1100 (e.g. communications networks 1116, 1131, 1135), or any combination thereof. For example, the software applications executing on the first, second, third, fourth, and/or fifth user devices 1102, 1106, 1110, 1121, 1125 and/or earphone devices 1115, 1130 may be applications for receiving data, applications for storing data, applications for auditioning, editing, storing and/or processing audio content, applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first, second, third, fourth, and/or fifth user devices 1102, 1106, 1110, 1121, 1125 and/or earphone devices 1115, 1130 may include associated telephone numbers, internet protocol addresses, device identities, or any other identifiers to uniquely identify the first, second, third, fourth, and/or fifth user devices 1102, 1106, 1110, 1121, 1125 and/or earphone devices 1115, 1130 and/or the first and second users 1101, 1120. In certain embodiments, location information corresponding to the first, second, third, fourth, and/or fifth user devices 1102, 1106, 1110, 1121, 1125 and/or earphone devices 1115, 1130 may be obtained based on the internet protocol addresses, by receiving a signal from the first, second, third, fourth, and/or fifth user devices 1102, 1106, 1110, 1121, 1125 and/or earphone devices 1115, 1130 or based on profile information corresponding to the first, second, third, fourth, and/or fifth user devices 1102, 1106, 1110, 1121, 1125 and/or earphone devices 1115, 1130.

The system 1100 may also include a communications network 1135. The communications network 1135 may be under the control of a service provider, the first and/or second users 1101, 1120, any other designated user, or a combination thereof. The communications network 1135 of the system 1100 may be configured to link each of the devices in the system 1100 to one another. For example, the communications network 1135 may be utilized by the first user device 1102 to connect with other devices within or outside communications network 1135. Additionally, the communications network 1135 may be configured to transmit, generate, and receive any information and data traversing the system 1100. In certain embodiments, the communications network 1135 may include any number of servers, databases, or other componentry. The communications network 1135 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 1140, 1145, and 1150 are shown as being included within communications network 1135. In certain embodiments, the communications network 1135 may be part of a single autonomous system that is located in a particular geographic region, or be part of multiple autonomous systems that span several geographic regions.

Notably, the functionality of the system 1100 may be supported and executed by using any combination of the servers 1140, 1145, 1150, and 1160. The servers 1140, 1145, and 1150 may reside in communications network 1135, however, in certain embodiments, the servers 1140, 1145, 1150 may reside outside communications network 1135. The servers 1140, 1145, and 1150 may provide and serve as a server service that performs the various operations and functions provided by the system 1100. In certain embodiments, the server 1140 may include a memory 1141 that includes instructions, and a processor 1142 that executes the instructions from the memory 1141 to perform various operations that are performed by the server 1140. The processor 1142 may be hardware, software, or a combination thereof. Similarly, the server 1145 may include a memory 1146 that includes instructions, and a processor 1147 that executes the instructions from the memory 1146 to perform the various operations that are performed by the server 1145. Furthermore, the server 1150 may include a memory 1151 that includes instructions, and a processor 1152 that executes the instructions from the memory 1151 to perform the various operations that are performed by the server 1150. In certain embodiments, the servers 1140, 1145, 1150, and 1160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 1140, 1145, 1150 may be communicatively linked to the communications network 1135, the communications network 1116, the communications network 1131, any network, any device in the system 1100, any program in the system 1100, or any combination thereof.

The database 1155 of the system 1100 may be utilized to store and relay information that traverses the system 1100, cache content that traverses the system 1100, store data about each of the devices in the system 1100 and perform any other typical functions of a database. In certain embodiments, the database 1155 may be connected to or reside within the communications network 1135, the communications network 1116, the communications network 1131, any other network, or a combination thereof. In certain embodiments, the database 1155 may serve as a central repository for any information associated with any of the devices and information associated with the system 1100. Furthermore, the database 1155 may include a processor and memory or be connected to a processor and memory to perform the various operation associated with the database 1155. In certain embodiments, the database 1155 may be connected to the earphone devices 1115, 1130, the servers 1140, 1145, 1150, 1160, the first user device 1102, the second user device 1106, the third user device 1110, the fourth user device 1121, the fifth user device 1125, any devices in the system 1100, any other device, any network, or any combination thereof.

The database 1155 may also store information and metadata obtained from the system 100, store metadata and other information associated with the first and second users 1101, 1120, store user profiles associated with the first and second users 1101, 1120, store device profiles associated with any device in the system 1100, store communications traversing the system 1100, store user preferences, store information associated with any device or signal in the system 1100, store information relating to patterns of usage relating to the first, second, third, fourth, and fifth user devices 1102, 1106, 1110, 1121, 1125, store audio content associated with the first, second, third, fourth, and fifth user devices 1102, 1106, 1110, 1121, 1125 and/or earphone devices 1115, 1130, store audio content and/or information associated with the audio content that is captured by the ambient sound microphones, store audio content and/or information associated with audio content that is captured by ear canal microphones, store any information obtained from any of the networks in the system 1100, store audio content and/or information associated with audio content that is outputted by ear canal receivers of the system 1100, store any information and/or signals transmitted and/or received by transceivers of the system 1100, store any device and/or capability specifications relating to the earphone devices 1115, 1130, store historical data associated with the first and second users 1101, 1115, store information relating to the size (e.g. depth, height, width, curvatures, etc.) and/or shape of the first and/or second user's 1101, 1120 ear canals and/or ears, store information identifying and or describing any eartip utilized with the earphone devices 1101, 1115, store device characteristics for any of the devices in the system 1100, store information relating to any devices associated with the first and second users 1101, 1120, store any information associated with the earphone devices 1115, 1130, store log on sequences and/or authentication information for accessing any of the devices of the system 1100, store information associated with the communications networks 1116, 1131, store any information generated and/or processed by the system 1100, store any of the information disclosed for any of the operations and functions disclosed for the system 1100 herewith, store any information traversing the system 1100, or any combination thereof. Furthermore, the database 1155 may be configured to process queries sent to it by any device in the system 1100.

The system 1100 may also include a software application, which may be configured to perform and support the operative functions of the system 1100, such as the operative functions of the first, second, third, fourth, and fifth user devices 1102, 1106, 1110, 1121, 1125 and/or the earphone devices 1115, 1130. In certain embodiments, the application may be a website, a mobile application, a software application, or a combination thereof, which may be made accessible to users utilizing one or more computing devices, such as the first, second, third, fourth, and fifth user devices 1102, 1106, 1110, 1121, 1125 and/or the earphone devices 1115, 1130. The application of the system 1100 may be accessible via an internet connection established with a browser program or other application executing on the first, second, third, fourth, and fifth user devices 1102, 1106, 1110, 1121, 1125 and/or the earphone devices 1115, 1130, a mobile application executing on the first, second, third, fourth, and fifth user devices 1102, 1106, 1110, 1121, 1125 and/or the earphone devices 1115, 1130, or through other suitable means. Additionally, the application may allow users and computing devices to create accounts with the application and sign-in to the created accounts with authenticating username and password log-in combinations. The application may include a custom graphical user interface that the first user 1101 or second user 1120 may interact with by utilizing a browser executing on the first, second, third, fourth, and fifth user devices 1102, 1106, 1110, 1121, 1125 and/or the earphone devices 1115, 1130. In certain embodiments, the software application may execute directly as an installed program on the first, second, third, fourth, and fifth user devices 1102, 1106, 1110, 1121, 1125 and/or the earphone devices 1115, 1130.

### Computing System for Facilitating the Operation and Functionality of the System

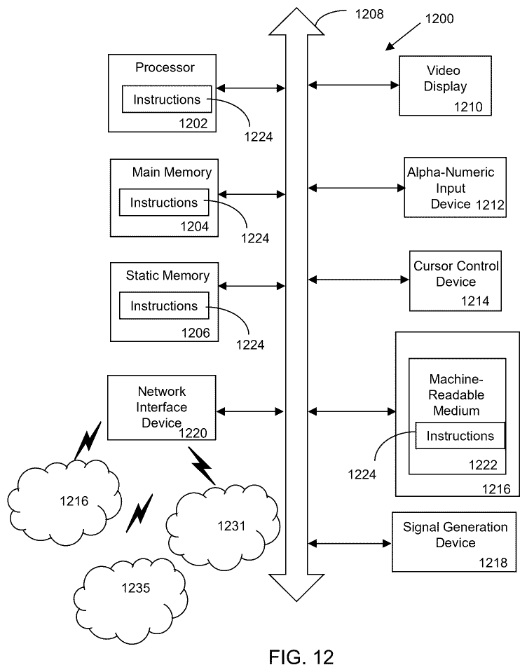

Referring now also to FIG. 12, at least a portion of the methodologies and techniques described with respect to the exemplary embodiments of the system 1100 can incorporate a machine, such as, but not limited to, computer system 1200, or other computing device within which a set of instructions, when executed, may cause the machine to perform any one or more of the methodologies or functions discussed above. The machine may be configured to facilitate various operations conducted by the system 1100. For example, the machine may be configured to, but is not limited to, assist the system 1100 by providing processing power to assist with processing loads experienced in the system 1100, by providing storage capacity for storing instructions or data traversing the system 1100, by providing functionality and/or programs for facilitating the operative functionality of the earphone devices 1115, 1130, and/or the first, second, third, fourth, and fifth user devices 1102, 1106, 1110, 1121, 1125 and/or the earphone devices 1115, 1130, by providing functionality and/or programs for facilitating operation of any of the components of the earphone devices 1115, 1130 (e.g. ear canal receivers, transceivers, ear canal microphones, ambient sound microphones, or by assisting with any other operations conducted by or within the system 1100.

In some embodiments, the machine may operate as a standalone device. In some embodiments, the machine may be connected (e.g., using communications network 1135, the communications network 1116, the communications network 1131, another network, or a combination thereof) to and assist with operations performed by other machines and systems, such as, but not limited to, the first user device 1102, the second user device 1111, the third user device 1110, the fourth user device 1121, the fifth user device 1125, the earphone device 1115, the earphone device 1130, the server 1140, the server 1150, the database 1155, the server 1160, or any combination thereof. The machine may be connected with any component in the system 1100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1200 may include a processor 1202 (e.g., a central processing unit (CPU), a graphics processing unit (GPU, or both), a main memory 1204 and a static memory 1206, which communicate with each other via a bus 1208. The computer system 1200 may further include a video display unit 1210, which may be, but is not limited to, a liquid crystal display (LCD), a flat panel, a solid state display, or a cathode ray tube (CRT). The computer system 1200 may include an input device 1212, such as, but not limited to, a keyboard, a cursor control device 1214, such as, but not limited to, a mouse, a disk drive unit 1216, a signal generation device 1218, such as, but not limited to, a speaker or remote control, and a network interface device 1220.

The disk drive unit 1216 may include a machine-readable medium 1222 on which is stored one or more sets of instructions 1224, such as, but not limited to, software embodying any one or more of the methodologies or functions described herein, including those methods illustrated above. The instructions 1224 may also reside, completely or at least partially, within the main memory 1204, the static memory 1206, or within the processor 1202, or a combination thereof, during execution thereof by the computer system 1200. The main memory 1204 and the processor 1202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1222 containing instructions 1224 so that a device connected to the communications network 1135, the communications network 1116, the communications network 1131, another network, or a combination thereof, can send or receive voice, video or data, and communicate over the communications network 1135, the communications network 1116, the communications network 1131, another network, or a combination thereof, using the instructions. The instructions 1224 may further be transmitted or received over the communications network 1135, another network, or a combination thereof, via the network interface device 1220.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

I claim:

1. A deformable ear device comprising:
a stent having a distal end and an anti-distal end;
a housing having a recess for a membrane attachment, an opening to accept the stent, and a grasp portion;
a tab configured to be attached to the anti-distal end of the stent; and
a membrane attached to the distal end of stent at one end of the membrane and attached to the recess of the housing at an opposing end of the membrane, wherein the membrane has an undeformed configuration at a first position of the stent with respect to the housing and wherein the membrane is deformed at a second position of the stent with respect to the housing.

2. The ear device according to claim 1 further comprising:
an ear canal microphone.

3. The ear device according to claim 2 further comprising:
a first ambient sound microphone.

4. The ear device according to claim 3 further comprising:
a second ambient sound microphone.

5. The ear device according to claim 3 further comprising:
a memory that stores instructions.

6. The ear device according to claim 5 further comprising:
a speaker.

7. The ear device according to claim 6 further comprising:
a processor, operatively connected to the ear microphone, wherein the processor is operatively connected to the first ambient sound microphone, where the processor is operatively connected to the speaker, where the processor is operatively connected to the memory, where the processor is configured to execute the instructions to perform operations, the operations comprising:
receiving a first microphone signal from the ear canal microphone;
receiving a second microphone signal from the first ambient sound microphone; and
analyzing the first microphone signal and second microphone signal to detect a voice of a user of the ear device.

8. The ear device according to claim 6 further comprising:
a processor, operatively connected to the ear microphone, wherein the processor is operatively connected to the first ambient sound microphone, where the processor is operatively connected to the speaker, where the processor is operatively connected to the memory, where the processor is configured to execute the instructions to perform operations, the operations comprising:
receiving an audio content signal;
receiving a first microphone signal from the ear canal microphone;
receiving a second microphone signal from the first ambient sound microphone; and
analyzing the first microphone signal and second microphone signal to generate an anti-noise signal.

9. The ear device according to claim 8, wherein the operations further comprise:
mixing the anti-noise signal with the audio content signal to generate a mixed signal.

10. The ear device according to claim 9, wherein the operations further comprise:
sending the mixed signal to the speaker.
